(19) United States
(12) Patent Application Publication
(10) Pub. No.: US 2026/0323160 A1
(43) Pub. Date: Oct. 15, 2026

(54) METHOD AND ELECTRONIC DEVICE FOR ACQUIRING IMAGE FOR BIOMETRIC RECOGNITION OF COMPANION ANIMAL

(71) Applicant: PETNOW INC., Seoul (KR)

(72) Inventors: Joon Ho LIM, Goyang-si (KR); Dae Hyun PAK, Seoul (KR); Seong Han KIM, Seoul (KR)

(73) Assignee: PETNOW INC., Seoul (KR)

(21) Appl. No.: 19/485,960

(22) PCT Filed: Nov. 24, 2023
(86) PCT No.: PCT/KR2023/019056

§ 371 Date: Nov. 19, 2025

(30) Foreign Application Priority Data
Jul. 25, 2023 (KR) 10-2023-0097013

(51) Int. Cl. H04N 23/67; G06T 7/00; G06V 40/10; H04N 23/63; H04N 23/667

(52) U.S. Cl. CPC H04N 23/671; G06T 7/0004; G06V 40/10; H04N 23/632; H04N 23/667; G06T 2207/30168

(57) ABSTRACT

Proposed are a method and an electronic device for controlling a camera to acquire an image suitable for biometric recognition of a companion animal. The method for acquiring the image for biometric recognition of the companion animal includes outputting a preview image of the companion animal captured by a camera, detecting a feature region for biometric recognition of the companion animal in the preview image, determining a focus distance to a position of the feature region while a focus mode of the camera is set to an auto-focus mode, applying a manual focus adjustment to the focus distance while the focus mode of the camera is switched to a manual focus mode, and storing the image for biometric recognition of the companion animal in a memory while a focus of the camera is set to the focus distance to which the manual focus adjustment is applied.

### TECHNICAL FIELD

The present disclosure relates to a method and an electronic device for acquiring an image for biometric recognition of a companion animal.

### BACKGROUND ART

In modern society, there is an increasing demand for companion animals that can provide emotional support while the companion animals live together with humans. For various additional services such as life cycle management and health management of the companion animals, there is an increasing need to store and manage information on the companion animals in a database. Such management requires identification information of each companion animal, and an object used for identification may be defined according to the type of companion animal. For example, similar to a human fingerprint, a nose print (the pattern of nose wrinkles) of a dog is known to be unique to each individual dog, and it is generally known that when a dog reaches adulthood (about six months old), this characteristic remains unchanged throughout the remainder of the life of the dog. Accordingly, the nose print of the dog may be used as a means for identification of the dog.

However, unlike a human who can assume a specific posture or can use various sensors, it is difficult to make a companion animal maintain a specific posture or to use a sensor on the animal. Since a verbal communication between a human and a companion animal is impossible, it might be considered to forcibly fix the animal in a particular posture or bring the animal into contact with a sensor by using a physical force or using a restraining frame. However, this is undesirable in terms of protecting the rights of the companion animal and avoiding repulsion from the owner of the companion animal. In addition, since a person is needed to hold the companion animal and another person is needed to operate a device for acquiring biometric information of the animal, there is a practical problem that it is difficult for a single person to acquire biometric information of the companion animal alone.

For the reasons described above, in a process of acquiring an image for biometric recognition of a companion animal, it is difficult to acquire an image having a quality appropriate for recognition or machine learning. Particularly, when a human directly photographs a companion animal, the focus or the exposure of the image is not suitable for artificial intelligence-based training and recognition. Therefore, when a user activates a camera toward a companion animal, it is necessary that an electronic device automatically controls the camera so that an image suitable f acquiring biometric information of the companion animal is acquired without control of the human.

### DISCLOSURE

### Technical Problem

The present disclosure is intended to provide a method and an electronic device for controlling a camera so as to acquire an image suitable for biometric recognition of a companion animal.

### Technical Solution

According to the present disclosure, there is provided a method for acquiring an image for biometric recognition of a companion animal, the method including: outputting a preview image of the companion animal captured by a camera provided in an electronic device; detecting a feature region for biometric recognition of the companion animal from the preview image; determining a focus distance to a position of the feature region while a focus mode of the camera is set to an auto-focus mode; applying a manual focus adjustment to the focus distance while the focus mode of the camera is switched to a manual focus mode; and acquiring the image for biometric recognition of the companion animal while a focus of the camera is set to the focus distance to which the manual focus adjustment is applied.

According to an aspect of the present disclosure, the applying of the manual focus adjustment may include changing the focus distance by adding or subtracting a manual focus adjustment value to or from an auto-focus distance that is set in the auto-focus mode.

According to an aspect of the present disclosure, the manual focus adjustment value may be set to be a fine adjustment value smaller than a specific percentage of the auto-focus distance.

According to an aspect of the present disclosure, the applying of the manual focus adjustment and the acquiring of the image for biometric recognition of the companion animal may be repeatedly performed at least two times.

According to an aspect of the present disclosure, the focus mode of the camera may be set to be periodically switched to the auto-focus mode at a predetermined interval.

According to an aspect of the present disclosure, the acquiring of the image for biometric recognition of the companion animal may include: identifying a feature object positioned within the feature region; performing a quality inspection on an image of the feature object; and storing the image of the feature object in a memory when the image satisfies a quality condition according to the quality inspection.

According to an aspect of the present disclosure, the acquiring of the image for biometric recognition of the companion animal may further include determining a manual focus adjustment value for the manual focus adjustment on the basis of the quality inspection.

According to an aspect of the present disclosure, there is provided a method for acquiring an image for biometric recognition of a companion animal, the method including: outputting a preview image of the companion animal captured by a camera provided in an electronic device; detecting a feature region for biometric recognition of the companion animal from the preview image; determining an exposure value of the feature region while an exposure mode of the camera is set to an auto-exposure mode; applying a manual exposure adjustment to the exposure value while the exposure mode of the camera is switched to a manual exposure mode; and acquiring the image for biometric recognition of the companion animal while the camera is set to the exposure value to which the manual exposure adjustment is applied.

According to an aspect of the present disclosure, there is provided an electronic device for acquiring an image for biometric recognition of a companion animal, the electronic device including: a camera configured to capture an image; a display configured to visually output the image; a processor functionally coupled to the camera and the display; and a memory functionally coupled to the processor. The processor may be configured to: output a preview image of the companion animal captured by the camera through the display; detect a feature region for biometric recognition of the companion animal from the preview image; determine a focus distance to a position of the feature region while a focus mode of the camera is set to an auto-focus mode; apply a manual focus adjustment to the focus distance while the focus mode of the camera is switched to a manual focus mode; and acquire the image for biometric recognition of the companion animal while a focus of the camera is set to the focus distance to which the manual focus adjustment is applied and then store the image in the memory.

According to an aspect of the present disclosure, there is provided an electronic device for acquiring an image for biometric recognition of a companion animal, the electronic device including: a camera configured to capture an image; a display configured to visually output the image; a processor functionally coupled to the camera and the display; and a memory functionally coupled to the processor. The processor may be configured to: output a preview image of the companion animal captured by the camera; detect a feature region for biometric recognition of the companion animal from the preview image; determine an exposure value of the feature region while an exposure mode of the camera is set to an auto-exposure mode; apply a manual exposure adjustment to the exposure value while the exposure mode of the camera is switched to a manual exposure mode; and acquire the image for biometric recognition of the companion animal while the camera is set to the exposure value to which the manual exposure adjustment is applied.

### Advantageous Effects

According to the present disclosure, in the state in which the focus mode of the camera is set to the auto-focus mode, the focus distance is primarily determined, and the manual focus adjustment is applied while the focus mode is switched to the manual focus mode, so that an image more suitable for biometric recognition is capable of being acquired.

### DESCRIPTION OF DRAWINGS

FIG. 1 is a block diagram illustrating a configuration of an electronic device according to the present disclosure.

FIG. 2 is a flowchart schematically illustrating a process of capturing an image for biometric recognition of a companion animal.

FIG. 3 shows an example of a screen output during a capturing process for biometric recognition of the companion animal.

FIG. 4 shows an auto-focus distance used in capturing the image for biometric recognition of the companion animal and a focus distance of the image suitable for biometric recognition.

FIG. 5 is a flowchart illustrating a method for acquiring biometric information of a companion animal according to the present disclosure.

FIG. 6a and FIG. 6b are views for describing a focus distance in the process of capturing the image for acquiring biometric information of the companion animal.

FIG. 7 is a flowchart illustrating a process of determining whether to acquire an image during the process of acquiring biometric information of the companion animal according to the present disclosure.

FIG. 8 is a flowchart illustrating a process of performing an exposure control during the process of acquiring biometric information of the companion animal according to the present disclosure.

### MODE FOR INVENTION

Hereinafter, exemplary embodiments of the present disclosure will be described in detail with reference to the accompanying drawings so that those skilled in the art can easily implement the present disclosure. The present disclosure is not limited to the exemplary embodiments described herein and may be embodied in many different forms.

In order to clearly describe the present disclosure, parts irrelevant to the description are omitted, and the same reference numerals designate the same or similar components throughout the specification.

In addition, in various exemplary embodiments, components having the same configuration will be described only in representative exemplary embodiments by using the same reference numerals, and in other exemplary embodiments, only configurations different from the representative exemplary embodiments will be described.

Throughout the specification, when a part is said to be “connected (or coupled)” to another part, an expression such as “connected (or coupled)” is intended to include not only “directly connected (or coupled)” but also “indirectly connected (or coupled)” having a different member interposed therebetween. In addition, it will be further understood that when a part “comprises”, “includes”, or “has” an element, this means that other elements are not excluded but may be further included, unless otherwise stated.

Unless defined otherwise, all terms used herein including technical or scientific terms have the same meanings as generally understood by a person having ordinary knowledge in the art to which the present disclosure pertains. The terms defined in general dictionaries are construed as having meanings consistent with the contextual meanings of the art, but not interpreted as ideal meanings or excessively formal meanings unless explicitly defined in the present application.

Hereinafter, a method and an electronic device for acquiring an image for biometric recognition of a companion animal according to the present disclosure will be described. Biometric information of a companion animal is acquired for verifying the identification of the companion animal. The biometric information of the companion animal may include iris information, facial shape information, body shape information, and nose wrinkle pattern (nose print) information. Although the present specification mainly describes capturing the nose print of a dog as biometric information of a companion animal, the scope of the companion animal is not limited to a dog or a cat, and the biometric information used for identification is not limited to the nose print and various physical characteristics of the companion animal may be used.

According to the present disclosure, an electronic device 1 captures the companion animal by using a camera 10, and acquires biometric information of the companion animal from the captured image. The electronic device 1 may be a mobile device such as a smartphone or a tablet. Alternatively, the electronic device 1 may be a computing device (for example, a laptop or desktop computer). In a mobile device such as a foldable phone capable of being folded and unfolded, respective front cameras may be present both before the mobile device is folded and after the mobile device is folded. In the electronic device 1 according to the present disclosure, the front camera may be provided inside a display 20 or may be provided outside the display 20.

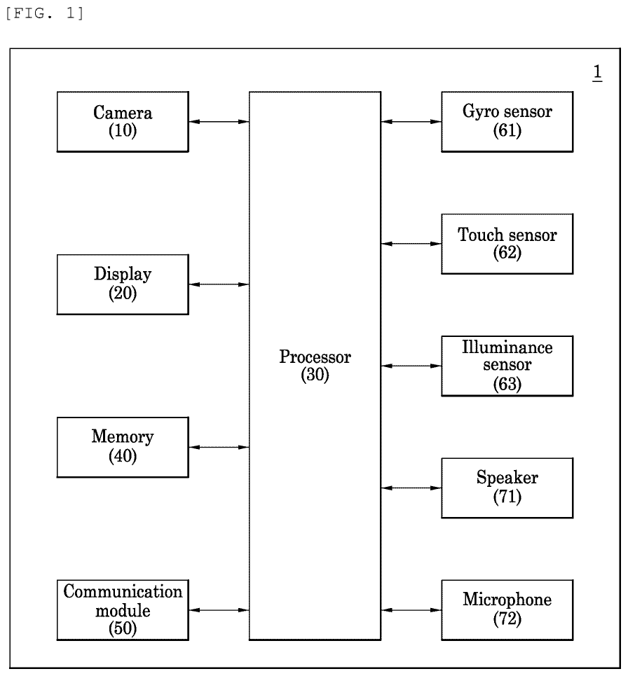

Referring to FIG. 1, the electronic device 1 includes the camera 10, the display 20, a processor 30, and a memory 40. Optionally, the electronic device 1 may further include a gyro sensor 61, a touch sensor 62, or an illuminance sensor 63. Optionally, the electronic device 1 may further include a communication module 50, a speaker 71, or a microphone 72.

The display 20 is a device configured to output visual information. The display 20 may include a panel and a control circuit. The touch sensor 62 may be disposed on the panel. Particularly, the display 20 may output an image (a preview image or a captured frame) of a companion animal being captured. In addition, the display 20 may output an interface providing information to a user during a process of acquiring biometric information of the companion animal.

The camera 10 is a device configured to capture an image (a still image or a video). The camera 10 may include at least one image sensor, a lens, a camera controller, an image processing processor, and a flash. The camera 10 may include a front camera and a rear camera. The camera 10 may capture an image for acquiring biometric information of the companion animal. Characteristics (for example, focus and exposure) of the camera 10 may be controlled so that a feature object for acquiring the biometric information of the companion animal is capable of being appropriately identified. The front camera is a camera configured to capture an image in a direction toward a display direction of the display 20, and the rear camera is a camera configured to capture an image in a direction toward a direction opposite to the display direction of the display 20. The camera 10 may include not only an internal camera mounted in the electronic device 1 but also an external camera connected to the electronic device 1 in a wired or wireless manner.

The processor 30 may perform computation and data processing for performing an operation of the electronic device 1, and may control each module of the electronic device 1. The processor 30 may execute at least one software program stored in the memory 40. The processor 30 may include a general purpose processor (for example, a CPU or an AP) configured to execute an operating system for managing overall operations of the electronic device 1. In addition, the processor 30 may include a dedicated processor (for example, a GPU or an NPU) for performing specific computational processing. The processor 30 may include at least one processing circuit. The processor 30 may perform a data processing and control operation for acquiring biometric information of the companion animal.

The memory 40 may store an operating system for operating the electronic device 1, a program such as an application, and data used during execution of the program. The memory 40 may include a volatile memory (for example, a DRAM) and a non-volatile memory (for example, a flash memory). The memory 40 may store an image for biometric recognition of the companion animal. In addition, the memory 40 may store, together with the image, biometric information of the companion animal and behavior information of a human.

The communication module 50 provides an environment in which the electronic device 1 is capable of communicating with an external entity (for example, a server, a base station, an IOT device, or a mobile device). The communication module 50 may include an antenna, an RF circuit, and a communication processor. The communication module 50 may provide data received from the external entity to the processor 30. The communication module 50 may convert data provided from the processor 30, and may transmit the converted data to the external entity. The communication module 50 may receive image data for biometric authentication of the companion animal provided from the processor 30, and may transmit the image data to a server.

The electronic device 1 may communicate with the server. The electronic device 1 may acquire biometric information (for example, a nose print image) of the companion animal, and may transmit the acquired biometric information to the server. The server may store the biometric information in the database. The server may perform data processing for training or identifying the companion animal by using the biometric information. The server may generate identification information of the companion animal from the biometric information, and may transmit the identification information to the electronic device 1.

A process of acquiring an image for biometric recognition of a companion animal described below may be performed by the electronic device 1 illustrated in FIG. 1.

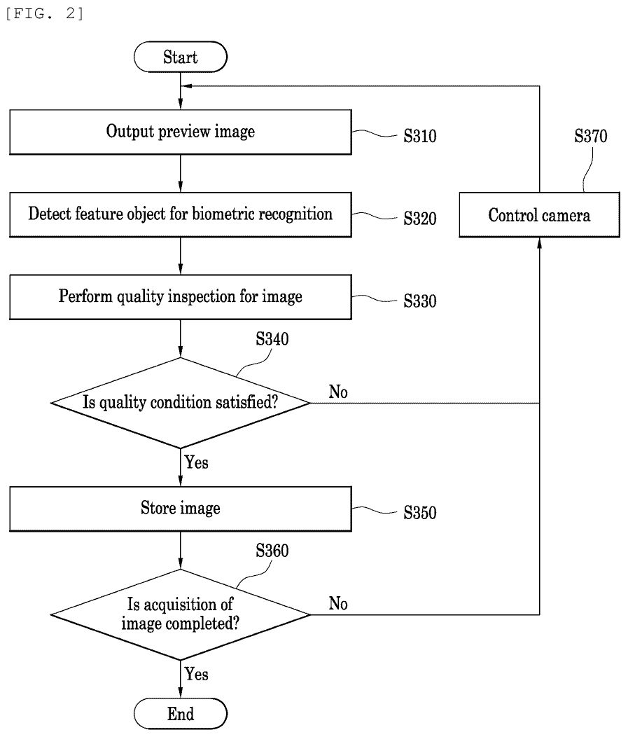

FIG. 2 is a flowchart schematically illustrating the process of acquiring the image for biometric recognition of the companion animal. As described above, in an image captured generally by the user, a focus or a brightness condition often fails to meet a requirement, so that a situation in which the image is not suitable for training and recognition based on artificial intelligence for biometric recognition of the companion animal. Particularly, unlike a human, since an animal does not recognize a behavior such as a photographing behavior and tends to continuously move its head, it is difficult to acquire a suitable image. In the method for acquiring the image for biometric recognition of the companion animal according to the present disclosure, when the user executes an application for biometric recognition of the companion animal and activates the camera toward the companion animal, the processor 30 of the electronic device 1 selectively acquires an image having a quality suitable for artificial intelligence-based learning or recognition from a screen being captured in real time. Accordingly, even the user who is not skilled in image capturing is capable of easily acquiring the image suitable for biometric recognition of the companion animal by using the electronic device 1.

Referring to FIG. 2, in a process S310, when the application for biometric recognition of the companion animal is executed and the camera 10 is activated, a preview image is output through a user interface of the application.

In a process S320, the processor 30 detects a feature object for biometric recognition from the preview image captured through the camera 10. For example, in a case of a dog, in order to acquire nose print information, the processor 30 may detect a nose region as a feature object within a facial region of the dog.

In a process S330, the processor 30 may perform a quality inspection on an image of the feature object. For example, the processor 30 may apply preprocessing to the image of the feature object, and may perform the quality inspection on the preprocessed image. The processor 30 may determine whether a size, a sharpness, a brightness, and so on of the image of the feature object satisfy a quality condition.

When it is determined that the quality condition of the image of the feature object is satisfied in a process S340, a process S350 is performed and the processor 30 may store the captured image in the memory 40 for biometric recognition.

In a process S360, the processor 30 determines whether image acquisition is completed. For example, when five images are required for biometric recognition of the companion animal and the number of stored images reaches five, the processor 30 may stop the image capturing. For example, when five images are required for biometric recognition of the companion animal but only two images are stored, the processor 30 may proceed to a process S370 so as to acquire additional images.

When the image of the feature object does not satisfy the quality condition in the process S340, the processor 30 does not use the captured image for biometric recognition and proceeds to the process S370. In the process S370, the processor 30 may control a setting of the camera so as to capture a next image. For example, the processor 30 may set a focus position to a position of the feature object (for example, a nose region 200) detected in a previous image. In addition, the processor 30 may adjust an exposure value of the camera 10 according to brightness information measured in the previous image. By controlling the current setting of the camera 10 on the basis of the object detection result and the quality inspection result of the previously captured image, the probability of acquiring an image suitable for biometric recognition of the companion animal may be increased.

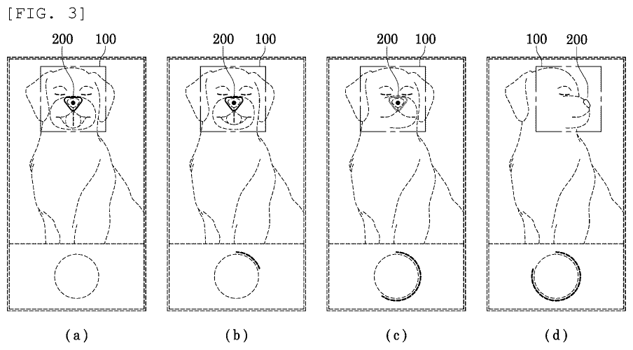

Referring to FIG. 3, when the application for biometric recognition of the companion animal is executed and the camera 10 is activated, the preview image is output through the user interface of the application. In a frame (a) in FIG. 3, a face region 100 and the nose region 200 of the dog are detected. When the nose print of the dog is used as biometric information, whether a corresponding frame is acquired is determined through the quality inspection of the image of the nose region 200. Position information of the nose detected in the frame (a) may be used for determining a focus position. Subsequently, detection of the nose position and the quality inspection are also performed in frames (b), (c), and (d), and an acquisition state of the biometric information may be displayed as an icon according to the image quality of the nose that is detected. For example, a color of an icon displayed overlapping with the position of the nose may change according to a result of the quality inspection of the image. For example, when the image of the nose that is captured is appropriate, the icon may be displayed in an orange color. Furthermore, when the image is inappropriate, the icon may be displayed in a gray color. In addition, a progress of capturing for biometric recognition of the companion animal may be displayed through a lower end of the interface.

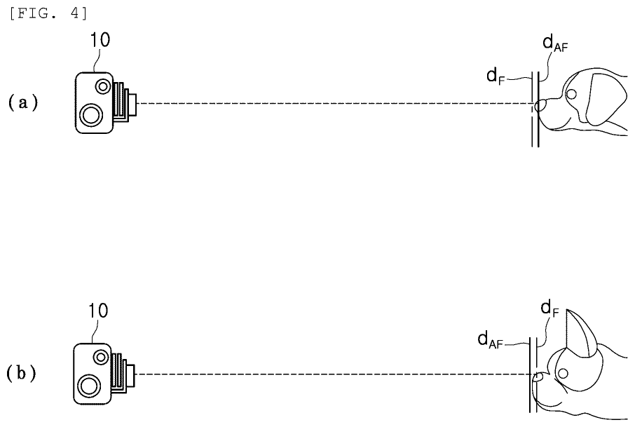

Meanwhile, in biometric recognition of the companion animal, it is required to acquire a clear image, and the sharpness of the image is determined mainly by the focus of the camera 10. Although most cameras provided in mobile devices support an auto-focus function, there is a problem in biometric recognition of the companion animal. The focus of the t camera 10 in an auto-focus mode is determined generally with respect to a center of a face region of an animal, and a focus position determined in the auto-focus mode may not match with the nose position of the dog. Referring to FIG. 4(a), an auto-focus distance d_{AF} according to the auto-focus mode is set to a distance from the camera 10 to a position around the mouth of the dog, whereas a focus distance de required for acquiring the nose print corresponds to a distance from the camera 10 to the nose position of the dog. That is, since the auto-focus distance d_{AF} is longer than the focus distance de suitable for acquiring the nose print, the sharpness of the nose image may not be ensured. Similarly, as shown in FIG. 4(b), the auto-focus distance d_{AF} may be shorter than the focus distance de suitable for acquiring the nose print. In this situation, the sharpness of the nose image may not be ensured as well.

Likewise, even when the camera 10 supports an auto-exposure mode that sets an exposure value according to ambient illuminance in the process of setting the exposure value of the camera 10, the exposure value determined by the auto-exposure mode may not match with the exposure value suitable for biometric recognition of the companion animal.

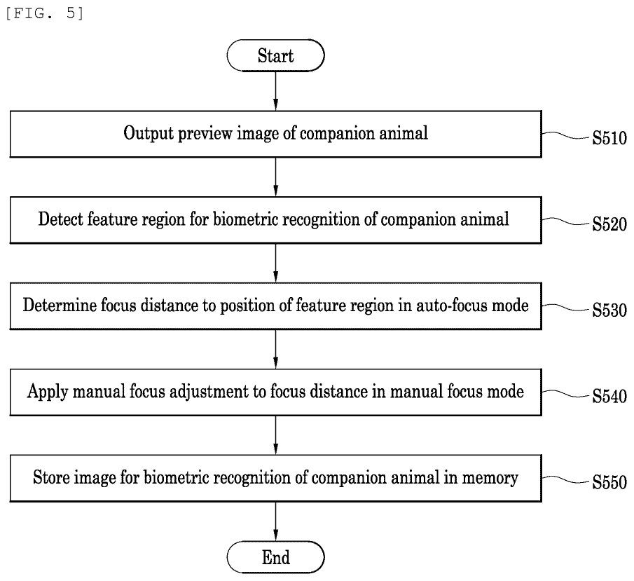

According to the present disclosure, while the auto-focus function and the auto-exposure function of the camera 10 provided in the electronic device 1 are utilized, the image is acquired by determining the focus and the exposure that are more suitable for biometric recognition of the companion animal. FIG. 5 is a flowchart illustrating the method for acquiring the image for obtaining biometric information of the companion animal according to the present disclosure. Processes shown in FIG. 5 may be executed by the processor 30.

The method for acquiring the image for biometric recognition of the companion animal according to the present disclosure includes: outputting a preview image of the companion animal captured by the camera 10 provided in the electronic device 1 S510; detecting a feature region for biometric recognition of the companion animal in the preview image S520; determining a focus distance on the basis of a position of the feature region while a focus mode of the camera 10 is set to the auto-focus mode S530; applying a manual focus adjustment to the focus distance while the focus mode of the camera 10 is switched to a manual focus mode S540; and storing an image for biometric recognition of the companion animal in the memory 40 while the focus of the camera 10 is adjusted to the focus distance in which the manual focus adjustment is applied S550.

In the process S510, when the application program for biometric recognition of the companion animal is executed, the camera 10 is activated, and image capturing by the camera 10 is performed. An image captured by the camera 10 is output as the preview image through the display 20.

In the process S520, the feature region for biometric recognition of the companion animal is detected from the preview image. The feature region may correspond to the face region or the nose region of the animal. Alternatively, the feature region may correspond to a face region of a cat. The feature region may be extracted by a detector (a feature detection algorithm) using deep learning.

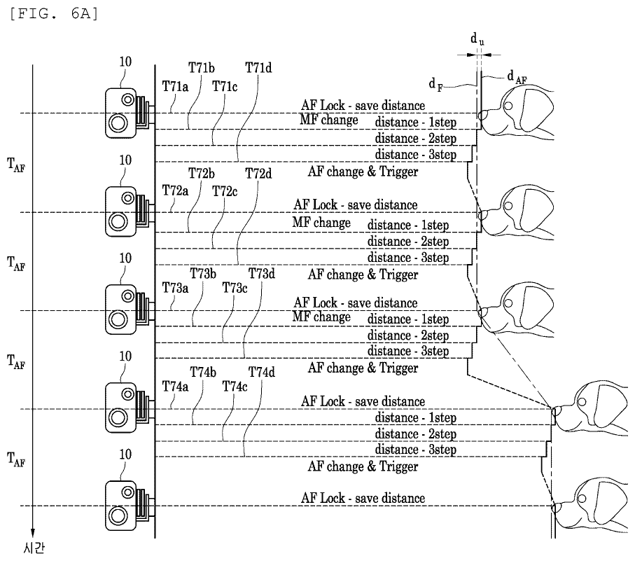

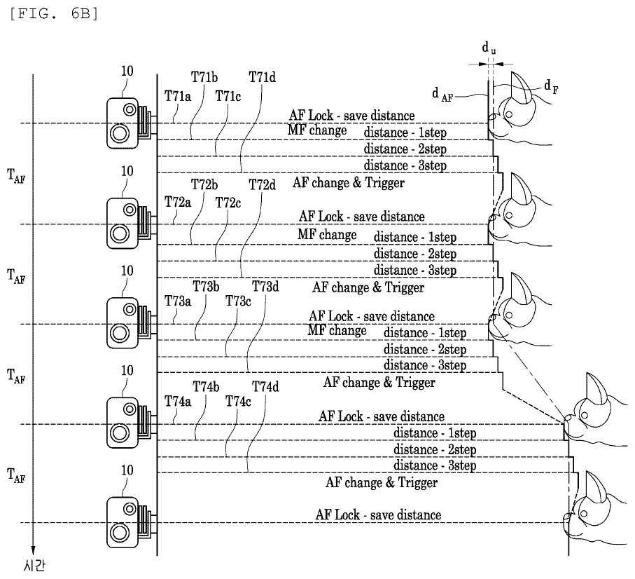

In the process S530, the focus mode of the camera is set to the auto-focus mode, and the focus distance is determined on the basis of the position of the feature region. The focus distance set in the auto-focus mode is referred to as the auto-focus distance d_{AF}. The auto-focus distance d_{AF} may correspond to a distance from the camera 10 to an arbitrary position (for example, a center position) within the feature region. For example, at a capturing start time T71a shown in FIG. 6a and FIG. 6b, the auto-focus distance d_{AF} according to the auto-focus mode is determined, and the camera 10 captures an image according to the determined auto-focus distance d_{AF}. At this time, the quality inspection and the determination on whether to acquire the captured image may be performed.

In the process S540, the focus mode of the camera 10 is switched to the manual focus mode, and fine adjustment of the focus distance is performed under the manual-focus mode. In the present disclosure, the manual focus adjustment refers to a process of re-setting the focus distance by adding or subtracting a predetermined distance unit (a manual focus adjustment value dᵤ) to or from the auto-focus distance d_{AF} of the camera 10.

The process S540 in which the manual focus adjustment is applied to the auto-focus distance d_{AF} includes changing the focus distance by adding or subtracting the manual focus adjustment value dᵤ to or from the auto-focus distance d_{AF}. Referring to FIG. 6a, at a capturing time T71b, a value obtained by subtracting the manual focus adjustment value du from the auto-focus distance d_{AF} is set to the focus distance of the camera 10. The manual focus-adjustment value du may be set to a fine adjustment value smaller than a specific percentage (for example, 5%) of the auto-focus distance d_{AF}. For example, when the auto-focus distance d_{AF} is 1 m, the manual focus adjustment value du may be determined to be 1 cm. A situation in which the focus distance is adjusted to be reduced is illustrated in FIG. 6a. However, adjusting the focus distance may also include a process of increasing the focus distance as illustrated in FIG. 6b. Referring to FIG. 6b, at the capturing time T71b, a value obtained by adding the manual focus adjustment value dᵤ to the auto-focus distance d_{AF} may be set to the focus distance of the camera 10.

Instead of using the auto-focus distance d_{AF} calculated through the auto-focus function as it is, the auto-focus distance d_{AF} may be finely adjusted, so that a sharper biometric image may be acquired. For example, at the capturing time T71b in FIG. 6a and FIG. 6b, when a nose print image is captured by using the focus distance to which the focus adjustment is applied, a sharper nose print image may be acquired than in a situation in which the auto-focus distance d_{AF} is used without adjustment.

In the process S550, in a state in which the focus of the camera 10 is set to the focus distance to which the manual focus adjustment is applied, an image for biometric recognition of the companion animal may be captured, and the quality inspection and the determination on whether to acquire the image may be performed. For example, at the capturing time T71b, the quality inspection and the acquisition determination for the image captured with the adjusted focus may be performed. Furthermore, when the quality condition is satisfied, the image may be stored in the memory 40.

The processes of applying the manual focus adjustment to the auto-focus distance d_{AF} and acquiring the image for biometric recognition of the companion animal may be repeatedly executed at least two times. Referring to FIG. 6a and FIG. 6b, at a capturing time T71c, an additional focus adjustment is performed on the focus distance at the previous capturing time T71b. The focus distance at the capturing time T71c may be determined by subtracting the manual focus adjustment value dᵤ from the focus distance at the previous capturing time T71b. At the capturing time T71c, the quality inspection for the acquired image and the storage of the image according to the determination of whether to acquire the image may be performed. In addition, at a capturing time T71d, the focus adjustment may be performed, and the quality inspection and the acquisition determination for the image may be performed. Such focus adjustments may be executed at least two times, and the number of adjustments may vary according to system design. The focus adjustment may be performed at a constant time interval (for example, 0.1 second), which may also be varied according to the system design.

While capturing for biometric recognition of the companion animal is continued, the focus adjustment for the auto-focus distance d_{AF} is repeatedly performed. Here, the focus mode of the camera 10 is in the manual focus mode. Meanwhile, the focus mode of the camera 10 may be periodically switched to the auto-focus mode at a predetermined time T_{AF}. An execution interval of the auto-focus mode may be set to a time (for example, 1 second) longer than a time interval (for example, 0.1 second) in which the focus adjustment is executed in the manual focus mode. Alternatively, after a predetermined number of focus adjustments are performed in the manual focus mode, the focus mode of the camera 10 may be switched to the auto-focus mode.

Since an animal has a habit of moving the head thereof, switching between the auto-focus mode and the focus adjustment according to the manual focus mode is repeatedly performed while the companion animal is captured. When the focus mode is switched to the auto-focus mode, the auto-focus distance d_{AF} according to the auto-focus mode is determined at a capturing time T72a, and the focus distance adjustment according to the manual focus mode is performed at capturing times T72b, T72c, and T72d. At a capturing time T73a, the focus mode of the camera 10 is switched to the auto-focus mode again, and focus distance adjustments according to the manual focus mode are performed at capturing times T73b, T73c, and T73d.

At a capturing time T74a, the focus mode of the camera 10 is set to the auto-focus mode, and the auto-focus distance d_{AF} is calculated again. Here, when the dog moves away from the camera 10, the auto-focus distance d_{AF} is set to be increased accordingly. Subsequently, at capturing times T74b, T74c, and T74d, a process of adjusting the focus such that an image having an appropriate focus is acquired may be performed by performing manual focus adjustments for the auto-focus distances d_{AF}.

Identification of the feature object and the quality inspection for the image captured according to the focus adjustment may be performed. For example, the face region 100 of the dog may first be detected as the feature region, the focus adjustment may be performed on the basis of the feature region, the nose region 200 within the face region 100 may be detected, and then the quality inspection and the image storage for the detected nose region 200 may be performed.

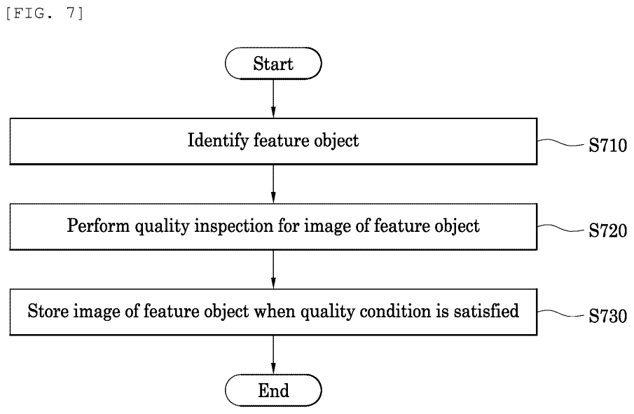

Referring to FIG. 7, a process S505 of acquiring the image for biometric recognition of the companion animal includes: identifying the feature object (for example, the nose region 200) positioned within the feature region (for example, the face region 100) S710; performing the quality inspection on the image of the feature object S720; and storing the image of the feature object in the memory 40 when the image satisfies the quality condition according to the quality inspection S730. Instead of the procedure shown in FIG. 7, an auto-focus setting and the quality inspection for the image of the nose region 200 may be performed by using the nose region 200 as the feature region.

According to an embodiment of the present disclosure, the process S505 of acquiring the image for biometric recognition of the companion animal may further include determining the manual focus adjustment value dᵤ for the manual focus adjustment on the basis of a result of the quality inspection. For example, when a degree of blur of the image of the feature object is evaluated and the degree of blur exceeds a reference value, the manual focus adjustment value du may be set to be larger than a default value since the feature object is not in focus under the auto-focus mode. Conversely, when the degree of blur of the image of the feature object is evaluated and the degree of blur is less than the reference value, the manual focus adjustment value du may be set to be smaller than the default value so as to adjust the focus in a fine amount since the current feature object is in focus under the auto-focus mode.

Meanwhile, during the process of acquiring the image for biometric recognition of the companion animal, exposure control for acquiring an image having an appropriate brightness may be performed in addition to the focus adjustment. The exposure control according to the present disclosure may be performed in parallel with the focus control described above.

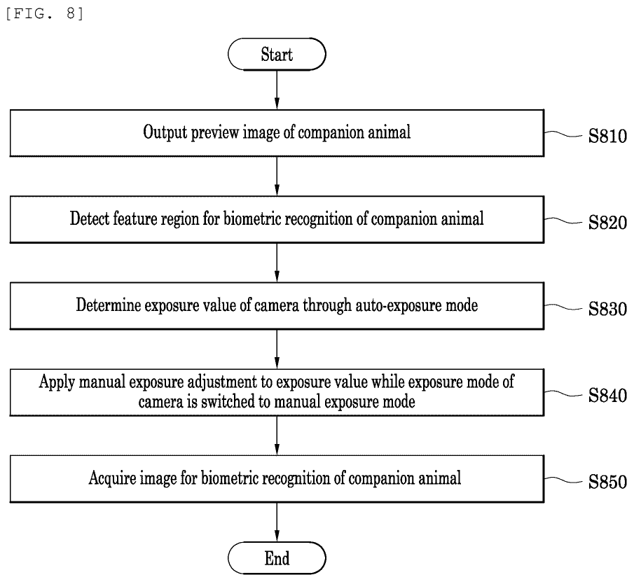

Referring to FIG. 8, the method for acquiring the image for biometric recognition of the companion animal according to the present disclosure includes: outputting a preview image of the companion animal captured by the camera 10 provided in the electronic device 1 S810; detecting the feature region for biometric recognition of the companion animal from the preview image S820; determining an exposure value of the feature region while an exposure mode of the camera 10 is set to an auto-exposure mode S830; applying a manual exposure adjustment to the exposure value while the exposure mode of the camera 10 is switched to a manual exposure mode S840; and acquiring the image for biometric recognition of the companion animal while the camera 10 is set with the exposure value to which the manual exposure adjustment is applied S850.

According to the present disclosure, the automatic exposure mode is performed first so that an automatic exposure value of the camera 10 is determined, and capturing is initiated on the basis of the determined exposure value. Then, by adding or subtracting a fine adjustment value (the manual exposure adjustment value) to or from the exposure value, the exposure value is changed, and the quality inspection and the determination on whether to acquire the captured images may be performed on the captured images on the basis of the changed exposure value.

The acquisition of the image for biometric recognition of the companion animal as described above may be performed by the electronic device 1. The electronic device 1 according to the present disclosure includes the camera 10 configured to capture an image, the display 20 configured to visually output the image, the processor 30 functionally coupled to the camera 10 and the display 20, and the memory 40 functionally coupled to the processor 30.

The processor 30 is configured to output the preview image of the companion animal captured by the camera 10 through the display 20, to detect the feature region for biometric recognition of the companion animal from the preview image, to determine a focus distance to the position of the feature region while the focus mode of the camera 10 is set to the auto-focus mode, to apply the manual focus adjustment to the focus distance while the focus mode of the camera 10 is switched to the manual focus mode, and to acquire the image for biometric recognition of the companion animal while the focus of the camera 10 is set to the focus distance to which the manual focus adjustment is applied.

According to an embodiment of the present disclosure, the processor 30 is configured to change the focus distance by adding or subtracting the manual focus adjustment value dᵤ to or from the auto-focus distance d_{AF} that is set by the auto-focus mode.

According to an embodiment of the present disclosure, the manual focus adjustment value du may be set to a fine adjustment value smaller than a specific percentage of the auto-focus distance d_{AF}.

According to an embodiment of the present disclosure, the process of applying the manual focus adjustment and the process of acquiring the image for biometric recognition of the companion animal may be repeatedly performed at least two times.

According to an embodiment of the present disclosure, the focus mode of the camera 10 is set to be periodically switched to the auto-focus mode at a predetermined interval.

According to an embodiment of the present disclosure, the processor 30 is configured to identify the feature object positioned within the feature region, to perform the quality inspection on the image of the feature object, and to store the image of the feature object in the memory 40 when the image satisfies the quality condition according to the quality inspection.

According to an embodiment of the present disclosure, the processor 30 may determine the manual focus adjustment value dᵤ for the manual focus adjustment on the basis of the result of the quality inspection.

The electronic device 1 according to the present disclosure may perform the operation for acquiring the image for biometric recognition of the companion animal.

According to an embodiment of the present disclosure, the processor 30 may output the preview image of the companion animal captured by the camera 10, may detect the feature region for biometric recognition of the companion animal from the preview image, may determine the exposure value of the feature region while the exposure mode of the camera 10 is set to the auto-exposure mode, may apply the manual exposure adjustment to the exposure value while the exposure mode of the camera 10 is switched to the manual exposure mode, and may acquire the image for biometric recognition of the companion animal while the camera 10 is set with the exposure value to which the manual exposure adjustment is applied.

The present exemplary embodiment and the accompanying drawings in this specification only clearly show a part of the technical idea included in the present disclosure, and it will be apparent that all modifications and specific exemplary embodiments that can be easily inferred by those skilled in the art within the scope of the technical spirit contained in the specification and drawings of the present disclosure are included in the scope of the present disclosure.

Therefore, the spirit of the present disclosure should not be limited to the described exemplary embodiments, and all things equal or equivalent to the claims as well as the claims to be described later fall within the scope of the concept of the present disclosure.

1. A method for acquiring an image for biometric recognition of a companion animal, the method comprising:
outputting a preview image of the companion animal captured by a camera provided in an electronic device;
detecting a feature region for the biometric recognition of the companion animal from the preview image;
determining a focus distance to a position of the feature region while a focus mode of the camera is set to first focus mode in which the focus distance is determined to a center of the feature region;
switching the focus mode from the first focus mode into a second focus mode in which the focus distance is adjusted by adding or subtracting a predefined value to the focus distance of the first focus mode;
determining a second focus distance by applying a focus adjustment to the first focus distance while the focus mode of the camera is switched to the second focus mode;
capturing an image including the feature region for the biometric recognition of the companion animal while a focus of the camera is set to the focus distance to which the focus adjustment is applied; and
selectively storing the image including the feature region according to a result of a quality inspection on the image.

2. The method of claim 1,
wherein the applying of the focus adjustment comprises changing the first focus distance by adding or subtracting a focus adjustment value to or from an auto-focus distance that is set in the first focus mode.

3. The method of claim 2,
wherein the focus adjustment value is set to be a fine adjustment value smaller than a specific percentage of the auto-focus distance.

4. The method of claim 1,
wherein the focus mode of the camera is set to be periodically switched to the first focus mode from the second focus mode at a predetermined interval.

5. The method of claim 1,
wherein the capturing of the image for the biometric recognition of the companion animal comprises:
identifying a feature object positioned within the feature region;
performing the quality inspection on an image of the feature object; and
storing the image of the feature object in a memory when the image satisfies a quality condition according to the quality inspection.

6. The method of claim 5,
wherein the capturing of the image for the biometric recognition of the companion animal further comprises determining a focus adjustment value for the focus adjustment based on the quality inspection.

7. A method for acquiring an image for biometric recognition of a companion animal, the method comprising:
outputting a preview image of the companion animal captured by a camera provided in an electronic device;
detecting a feature region for the biometric recognition of the companion animal from the preview image;
determining first exposure value of the feature region while an exposure mode of the camera is set a first exposure mode in which the exposure value is determined according to ambient illuminance of the camera;
switching the exposure mode into a second exposure mode in which the exposure value is adjusted by adding or subtracting a predefined value to the first exposure value;
determining a second exposure value by applying a exposure adjustment to the first exposure value while the exposure mode of the camera is switched to the second exposure mode; and
capturing an image including the feature region for the biometric recognition of the companion animal while the camera is set to the second exposure value to which the exposure adjustment is applied; and
selectively storing the image including the feature region according to a result of a quality inspection on the image.

8. An electronic device for acquiring an image for biometric recognition of a companion animal, the electronic device comprising:
a camera;
a display;
a processor functionally coupled to the camera and the display; and
a memory functionally coupled to the processor,
wherein the processor is configured to:
output a preview image of the companion animal captured by the camera through the display;
detect a feature region for the biometric recognition of the companion animal from the preview image;
determine a first focus distance to a position of the feature region while a focus mode of the camera is set to first focus mode in which the focus distance is determined to a center of the feature region;
switch the focus mode from the first focus mode into a second focus mode in which the focus distance is adjusted by adding or subtracting a predefined value to the focus distance of the first focus mode;
determine a second focus distance by applying a focus adjustment to the first focus distance while the focus mode of the camera is switched to the second focus mode;
capture an image including the feature region for the biometric recognition of the companion animal while a focus of the camera is set to the second focus distance to which the focus adjustment is applied;
selectively store the image including the feature region in the memory according to a result of a quality inspection on the image.

9. The electronic device of claim 8,
wherein the processor is configured to change the first focus distance by adding or subtracting a focus adjustment value to or from an auto-focus distance that is set in the first focus mode.

10. The electronic device of claim 9,
wherein the focus adjustment value is set to be a fine adjustment value smaller than a specific percentage of the auto-focus distance.

11. The electronic device of claim 8,
wherein the focus mode of the camera is set to be periodically switched to the first focus mode from the second focus mode at a predetermined interval.

12. The electronic device of claim 8,
wherein the processor is configured to identify a feature object positioned within the feature region, to perform the quality inspection on an image of the feature object, and to store the image of the feature object in the memory when the image satisfies a quality condition according to the quality inspection.

13. The electronic device of claim 12,
wherein the processor is configured to determine a focus adjustment value for the focus adjustment based on the quality inspection.

14. (canceled)
